(19) United States
(12) Patent Application Publication
(10) Pub. No.: US 2026/0280881 A1
(43) Pub. Date: Sep. 17, 2026

(54) METHODS AND APPARATUS FOR OFFLINE CRYPTOGRAPHIC CREDENTIAL VERIFICATION

(71) Applicant: Adyton PBC, Wilmington, DE (US)

(72) Inventors: Gordon J. YOUNG, Gilbert, AZ (US); Jason FREE, Highlands Ranch, CO (US); James A. BOYD, Scottsdale, AZ (US)

(21) Appl. No.: 19/080,038

(22) Filed: Mar. 14, 2025

(51) Int. Cl. H04L 9/32; H04L 9/08

(52) U.S. Cl. CPC H04L 9/3218; H04L 9/0825; H04L 9/0894

(57) ABSTRACT

In some embodiments, a method includes initiating a peer-to-peer communication with a compute device. The method further includes receiving a public cryptographic key of an entity associated with a credential of the compute device. The method further includes receiving a Merkle tree root having a signature of a private cryptographic key of the entity. The method further includes verifying the signature using the public cryptographic key of the entity, to identify trust of the Merkle tree root. The method further includes receiving a zero-knowledge proof associated with the credential of the second compute device. The method further includes confirming validity of the zero-knowledge proof based on the Merkle tree root. The method further includes selecting, in response to confirming validity of the zero-knowledge proof, data to send to the compute device via the peer-to-peer communication based on the zero-knowledge proof.

### FIELD

One or more embodiments described herein relate to systems and methods for credential verification among operators, and more specifically credential verification among operators engaged in an offline or peer-to-peer communication.

### BACKGROUND

In some industries, organizations may rely on internet access control systems that authenticate users and manage revocations via cloud-based services or dedicated servers. While these solutions can function in environments with reliable network connectivity, they become impractical or insecure in scenarios where network access is limited or intermittent. Additionally, some known approaches to offline verification may rely on static credentials (e.g., printed badges) that lack robust security features and/or may not support timely revocation. Furthermore, some known approaches may reveal specific roles or sensitive access details to prove authorization, which compromises user or organizational confidentiality. These limitations can become evident in cross-domain collaborations where multiple stakeholders-people, devices, or AI agents-may desire to interact securely without disclosing confidential internal structures. Consequently, there is a need for an efficient and privacy-preserving method to verify role-based entitlements in offline or low-connectivity settings, ensuring secure access control without depending on continuous network availability or exposing sensitive information.

### SUMMARY

In one or more embodiments, a method includes: initiating, using a processor of a first compute device, a peer-to-peer communication with a second compute device, the first compute device not connected to a network outside of the peer-to-peer communication. The method further includes receiving, at the processor and from the second compute device via the peer-to-peer communication, a public cryptographic key of an entity associated with a credential of the second compute device. The method further includes receiving, at the processor and from the second compute device via the peer-to-peer communication, a Merkle tree root having a signature of a private cryptographic key of the entity. The method further includes verifying, at the processor, the signature using the public cryptographic key of the entity, to identify trust of the Merkle tree root. The method further includes receiving, at the processor and from the second compute device via the peer-to-peer communication, a zero-knowledge proof associated with the credential of the second compute device. The method further includes confirming validity of the zero-knowledge proof based on the Merkle tree root. The method further includes selecting, in response to confirming validity of the zero-knowledge proof, data to send to the second compute device via the peer-to-peer communication based on the zero-knowledge proof.

In one or more embodiments, a non-transitory, processor-readable medium stores instructions that, when executed by a processor, cause the processor to initiate, with a first compute device, a peer-to-peer communication with a second compute device, the first compute device not connected to a network outside of the peer-to-peer communication. The processor is caused further to send, to the second compute device via the peer-to-peer communication, a public cryptographic key of a first entity, the public cryptographic key of the first entity being signed by a private cryptographic key of a second entity. The processor is caused further to send, to the second compute device via the peer-to-peer communication, a first Merkle tree root signed by the private cryptographic key of the first entity. The processor is caused further to receive, from the second compute device via the peer-to-peer communication, a public cryptographic key of the second entity, the public cryptographic key of the second entity being signed by a private cryptographic key of the first entity. The processor is caused further to receive, from the second compute device via the peer-to-peer communication, a second Merkle tree root signed by the private cryptographic key of the second entity; and verify a signature of the second Merkle tree root using the public cryptographic key of the second entity, to identify trust of the second Merkle tree root. The processor is caused further to receive, from the second compute device via the peer-to-peer communication, a first zero-knowledge proof associated with a credential of the second compute device. The processor is caused further to confirm validity of the first zero-knowledge proof based on the second Merkle tree root. The processor is caused further to send, to the second compute device via the peer-to-peer communication, a second zero-knowledge proof associated with a credential of the first compute device. The processor is caused further to select, in response to confirming validity of the first zero-knowledge proof, data to send to the second compute device via the peer-to-peer communication based on the first zero-knowledge proof. The processor is caused further to receive data from the second compute device via the peer-to-peer communication based on the second zero-knowledge proof.

### BRIEF DESCRIPTION OF THE DRAWINGS

FIG. 1 shows a system block diagram of an offline cryptographic verification system, according to an embodiment.

FIG. 2 shows a system block diagram of a cryptographic credential distribution system, according to an embodiment.

FIG. 3 shows a diagram of an example Merkle tree, according to an embodiment.

FIG. 4 shows a flowchart of an example method for offline cryptographic verification, according to an embodiment.

FIG. 5 shows a flowchart of an example method for cryptographic credential distribution and offline cryptographic verification, according to an embodiment.

### DETAILED DESCRIPTION

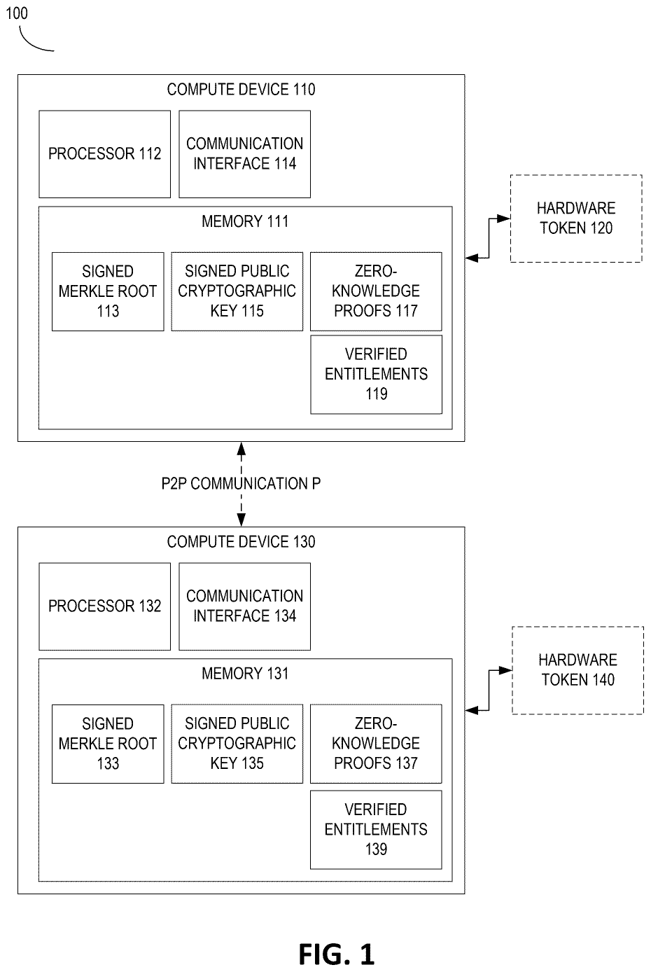

FIG. 1 shows a system block diagram of an offline cryptographic verification system 100, according to an embodiment. The offline cryptographic verification system 100 includes a compute device 110, a hardware token 120, a compute device 130, a hardware token 140, and a peer-to-peer communication P. The offline cryptographic verification system 100 can be a system for verifying entitlements (also referred to herein as credentials), such as, for example, access entitlements, role-based entitlements, or cross-entity credentials, in environments with limited or no connectivity. The offline cryptographic verification system 100 can allow devices to prove entitlements through the exchange of zero-knowledge proofs or, in some implementations, individual entitlements, without disclosing a full set of entitlements and/or more information than is used to verify a specific entitlement. The offline cryptographic verification system 100 can be decentralized such that participating devices do not use a connection to a central device and/or network. The offline cryptographic verification system 100 can be deployed in, for example, remote facilities, field operations, or multi-entity collaborations.

The compute device 110 can be any suitable hardware-based computing device configured to send and/or receive data and configured to store cryptographic data (e.g., a cryptographic key, a cryptographic proof, a hash, etc.). For example, in some embodiments, the compute device 110 can be, for example, a mobile compute device, an internet-of-things device, a personal computer (PC), a server, a workstation, a smartphone, a smartwatch, a tablet, a laptop computer, an unmanned aerial vehicle (e.g., a drone), and/or the like. In some implementations, the compute device 110 can receive inputs and/or data from a user interacting with the compute device 110 (e.g., via the hardware token 120, via an input device such as a keyboard, mouse, microphone, etc.). The compute device 110 can be a compute device associated with (e.g., trusting and trusted by) an entity (e.g., an authoritative body, a government body, an agency, an organization, a committee, a corporation, and/or the like). For example, the compute device 110 can be a compute device associated with a company engaged in a project with multiple partner companies. As another example, the compute device 110 can be a compute device associated with a government entity of a first country engaged in collaboration with a government entity of a second country.

The compute device 110 includes a processor 112, a communication interface 114, and a memory 111. The processor 112 can be a hardware-based integrated circuit (IC) and/or any other suitable processing device configured to run or execute a set of instructions and/or code stored, for example, in the memory 111. For example, the processor 112 can be a general-purpose processor, a central processing unit (CPU), a graphics processing unit (GPU), an accelerated processing unit (APU), an application specific integrated circuit (ASIC), a network processor, a front-end processor, a field programmable gate array (FPGA), a programmable logic array (PLA), and/or the like. The processor 112 can be in communication with the memory 111 via any suitable interconnection, system bus, circuit, and/or the like. The processor can include a trusted execution environment (e.g., Intel SGX, etc.) configured to perform cryptographic operations. Further, the trusted execution environment can be a secure area within the processor 112 that isolates and protects sensitive data (e.g., cryptographic keys, etc.) and processes (e.g., verifying cryptographic structures, generating and/or validating cryptographic proofs, etc.), ensuring confidentiality and integrity even if the compute device 110 is compromised. As described in further detail herein, the processor 112 can include any number of engines, processing units, cores, etc. configured to execute code, instructions, modules, processes, and/or functions associated with verifying cryptographic structures (e.g., a signed Merkle root 133), generating cryptographic proofs (e.g., zero-knowledge proofs 117, verifiable credentials, etc.) and/or validating cryptographic proofs (e.g., zero-knowledge proofs 137, verifiable credentials, etc.), and exchanging data with devices coupled to the compute device 110 (e.g., the compute device 130 via the peer-to-peer communication P, the hardware token 120, or another device not shown in FIG. 1).

The communication interface 114 can be a communication interface device used to couple the compute device 110 to devices (e.g., the compute device 130 via the peer-to-peer communication P, the hardware token 120, etc.). The communication interface 114 can be used to discover nearby devices and establish communications such as, for example, a Bluetooth communication, a Bluetooth low energy communication, a Wi-Fi communication, a Wi-Fi direct communication, a Wi-Fi ad-hoc communication, a radio communication, a wireless communication, and/or a wired connection to nearby devices such as the compute device 130, the hardware token 120, or another compute device (not shown in FIG. 1). The communication interface 114 can be communicatively coupled to a network (e.g., the internet; not shown in FIG. 1) when the compute device 110 is in the range of coverage of the network and can establish communications with other compute devices (not shown in FIG. 1) via the network. The communication interface 114 can enable the exchange of data between the compute device 110 and nearby devices, such as a signed Merkle root, a signed public cryptographic key, verified credentials, and/or zero-knowledge proof messages.

The memory 111 can be, for example, a stack memory, a random-access memory (RAM), a memory buffer, a magnetic disk (e.g., hard drive memory), a read-only memory (ROM), a semiconductor-based memory (e.g., a solid-state memory), an erasable programmable read-only memory (EPROM), a flash memory, and/or the like. The memory 111 can include a trusted execution environment (e.g., Intel SGX, etc.) configured to store, for example, sensitive data including cryptographic keys, verified entitlements, and one or more software modules and/or code that can include instructions that can cause the processor 112 to perform one or more processes, functions, and/or the like (e.g., processes, functions, etc. associated with verifying cryptographic structures (e.g., the signed Merkle root 133), generating cryptographic proofs (e.g., the zero-knowledge proofs 117, verifiable credentials, etc.) and/or validating cryptographic proofs (e.g., the zero-knowledge proofs 137, verifiable credentials, etc.), and exchanging data with devices coupled to the compute device 110 (e.g., the compute device 130 via the peer-to-peer communication P, the hardware token 120, or another device not shown in FIG. 1)).

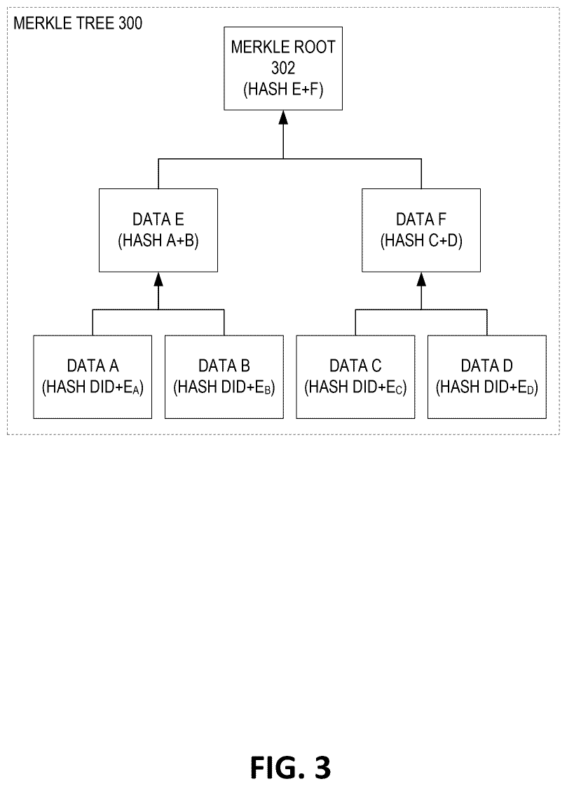

The memory 111 includes and/or stores a signed Merkle root 113, verified entitlements 119, a signed public cryptographic key 115, and/or zero-knowledge proofs 117. The signed Merkle root 113 can be a signed root node of a hash tree such as, for example, a Merkle tree. Merkle trees are discussed in further detail herein with respect to FIG. 3. The Merkle tree can be used to encode (e.g., hash) the verified entitlements 119 associated with the compute device 110. The Merkle tree can be a tree structure including multiple nodes where each parent node is a hash of any child nodes of the parent node, and the root node (also known as the Merkle root) has no parent node. In some implementations, each leaf node can be a hash of a user identifier (e.g., username, identifier number, etc.) and/or a verified entitlement of the verified entitlements 119. In some implementations, each leaf node of the Merkle tree can be a verified entitlement from the verified entitlements 119. In some implementations, each leaf node can be a hash of the user identifier and/or a zero-knowledge proof of a verified entitlement of the verified entitlements 119. The user identifier (also referred to herein as a decentralized identifier (DID)) can be unique not only to the compute device 110 but also to a user of the compute device 110 so as to establish a hardware proven bond between the specific user and the compute device 110. For example, the DID can offer proof that the compute device 110 is a compute device of the specific user. The DID can be recognized by a trust framework among multiple entities (e.g., multiple authoritative bodies, government bodies, agencies, organizations, committees, corporations, and/or the like). Stated another way, the decentralized identifier can provide a globally unique reference to the compute device 110, a user, and/or a user of the compute device 110 as recognized by the trust framework of participating entities.

The signed Merkle root 113 can be signed by a private cryptographic key of the entity (e.g., an issuing entity and/or a verifying entity). The signature by the private cryptographic key can be representative of authenticity of the signed Merkle root 113 as recognized by the entity The compute device 110 can receive the signed Merkle root 113 and/or other data from the Merkle tree (e.g., Merkle leaves, a Merkle path, etc.) from the compute device associated with the entity. The data from the Merkle tree can be used to, for example, generate and/or verify the zero-knowledge proofs 117. The signed Merkle root 113 can be exchanged with devices coupled to the compute device (e.g., the compute device 130 or another device not shown in FIG. 1, via the peer-to-peer communication P) to demonstrate trust among the compute device 110 and the entity.

In some implementations, the signed Merkle root 113 can expire, such that the compute device 110 may periodically and/or sporadically receive an updated Merkle root including a new or updated signature of the private cryptographic key of the entity (e.g., the issuing entity and/or the verifying entity). The signed Merkle root 113 can expire, for example, according to an expiration timestamp defined by the entity (also referred to herein as a predetermined expiration), or according to an update to a revocation list (e.g., a cryptographic accumulator, etc.) maintained and published by the entity. The expiration timestamp can be in the range of, for example, one hour, one day, one week, one month, three months, six months, one year or more from issuance of the signed Merkle root 113. In some implementations, the signed Merkle root 113 can be revoked prior to the expiration timestamp by the entity (e.g., the issuing entity and/or the verifying entity).

In response to receiving a signed Merkle root (e.g., the signed Merkle root 133), the compute device 110 can determine whether the signed Merkle root is expired. In attempting to verify the signature of the signed Merkle root, the compute device 110 can, for example, compare an expiration timestamp of the signature to the current date and/or time. In response to determining the current date and/or time is before the expiration timestamp, the compute device 110 can determine the signature of the signed Merkle root is valid and can subsequently verify the signed Merkle root using a signed public cryptographic key. In response to determining the current date and/or time is after the expiration timestamp, the compute device 110 can determine the signed Merkle root has expired and subsequently the verification fails. In some implementations, the expiration timestamp is also signed by the private key of an entity (e.g., issuing entity and/or verifying entity) to prevent tampering of the expiration timestamp. Accordingly, in such implementations, the expiration timestamp can be verified using the public key of the entity (e.g., the issuing entity and/or verifying entity).

In an alternative example, in some implementations, the compute device 130 may not store the verified entitlements 119. Instead, or in addition, the compute device 130 can store a witness tied to a specific accumulator state of a cryptographic accumulator of entitlements. The entity can update the cryptographic accumulator to remove the entitlement, thereby invalidating a signed Merkle root. The compute device 130, meanwhile, may not generate or receive a new witness because the stored witness is invalid with respect to the new accumulator state. During a peer-to-peer communication with another compute device (e.g., the compute device 110), the compute device 130 (or the hardware token 140) may be unable to generate a zero-knowledge proof because the stored witness no longer proves membership in the new accumulator state. In implementations where the zero-knowledge proof is pre-generated, the compute device 110 may be unable to verify the signed Merkle root against the new accumulator state. Subsequently, the entitlement verification may fail.

The verified entitlements 119 can be, for example, access entitlements or access credentials such as access to a building, site, or zone, usage of a resource or equipment, control of a device (e.g., a drone) or body, entitlement to view confidential information, and/or the like. The entitlements can be, for example, role-based (e.g., a certified medic, a certified drone operator, a hazardous material specialist, a member of a search and rescue team, a specific clearance level, and/or the like) specifying an entitlement associated with the role (e.g., administering medication, operating a drone, handling hazardous material, entering a restricted site to rescue someone, allowing access to certain information, and/or the like). The verified entitlements 119 can link the DID of the compute device 110 (or the user of the compute device 110) to the signature of the signed Merkle root 113. The compute device 110 can receive the verified entitlements 119 and/or data used to generate and/or verify the zero-knowledge proofs 117 (e.g., proof parameters including a proving key, a verification key, etc.) from a compute device associated with the entity (e.g., a server, not shown in FIG. 1). In some implementations, the compute device 110 can submit entitlements to a compute device associated with the entity (e.g. a server, not shown in FIG. 1). In some implementations, the entities (e.g., various distinct entities generating entitlements) of the trust framework can provide the entitlement set(s) of one or more associated compute devices (e.g., the compute device 110, the compute device 130, and/or another compute device not shown in FIG. 1) to a compute device configured to verify the entitlements to produce verified entitlements (e.g., the verified entitlements 119, the verified entitlements 139, etc.), and/or send the verified entitlements and/or data associated with the verified entitlements to the one or more associated compute devices.

The signed public cryptographic key 115 can be a public cryptographic key of a public-private cryptographic key pair of the entity (e.g., the issuing entity and/or the verifying entity). The signed public cryptographic key 115 can be signed by one or more private cryptographic keys of one or more cross-entities to demonstrate trust among the entity and the one or more cross-entities. For example, the entity can be entity A, the cross-entities can be entity B and entity C, where entities A, B, and C are partner entities in a search and rescue operation in a remote environment and desire a framework to demonstrate trust among operators in the remote environment. In such an example, the public cryptographic key 115 of entity A can be signed by the private cryptographic keys of entity B and entity C to show that entity B and entity C trust the public cryptographic key 115 of entity A. The compute device 110 can receive the signed public cryptographic key 115 from the compute device of the entity. The signed public cryptographic key 115 can be exchanged with devices coupled to the compute device (e.g., the compute device 130 or another device not shown in FIG. 1, via the peer-to-peer communication P) to verify an authenticity of the signed Merkle root 113.

While shown in FIG. 1 as being stored in the memory 111, in some implementations the signed public cryptographic key 115 can be stored in the hardware token 120. The hardware token 120 can be a secure hardware environment configured to store cryptographic keys, to perform cryptographic operations including generating and/or validating cryptographic proofs, and/or to provide platform-level attestation. The hardware token 120 can be, for example, a YubiKey having a direct connection (e.g., a universal serial bus (USB) connection, etc.) or a wireless coupling (e.g., near-field communication, etc.) to the communication interface 114. The hardware token 120 can be, for example, a security token, or any other suitable hardware-based authenticator. In response to the communication interface 114 initiating the peer-to-peer communication P with a nearby compute device (e.g., the compute device 130 or another device not shown in FIG. 1), the compute device 110 can retrieve the signed public cryptographic key 115 from the hardware token 120 and send the signed public cryptographic key 115 to the nearby compute device. The hardware token 120 can receive input from the user (e.g., input including a hardware switch or button) to generate the zero-knowledge proofs 117 by inputting the Merkle leaf associated with the verified entitlement, the Merkle root, the Merkle path, proof parameters (e.g., the proving key, verification key, etc.) and/or other data to a zero-knowledge proof (ZKP) generator (e.g., zk-SNARK, zk-STARK, Bulletproofs, etc.) of the hardware token 120. In response, the compute device 110 can retrieve the zero-knowledge proofs 117 from the hardware token 120 and send the zero-knowledge proofs 117 to the nearby compute device. In implementations without a hardware token 120, the functions described herein as being performed in the hardware token 120 (e.g., storing the signed public cryptographic key 115 and generating the zero-knowledge proofs 117) can be performed by the processor 112 and memory 111 of the compute device 110. In some implementations, the zero-knowledge proofs 117 can be generated by inputting the verified entitlement, the Merkle root, the Merkle path, proof parameters and/or other data into the ZKP generator of the hardware token 120.

The zero-knowledge proofs 117 can be a cryptographic method allowing the compute device 110 to offer proof to another compute device (e.g., the compute device 130 or another compute device not shown in FIG. 1) that the compute device 110 has a verified entitlement, without revealing verified entitlements 119. The zero-knowledge proofs 117 can be generated by inputting one or more of the verified entitlement, the Merkle leaf associated with the verified entitlement, the DID, the Merkle root, the Merkle path, the proof parameters (e.g., a proving key, verification key, etc.) and/or other data into a zero-knowledge proof (ZKP) generator (e.g., zk-SNARK, zk-STARK, Bulletproofs, etc.) of the trusted execution environment of the processor 112. The zero-knowledge proofs 117 can be exchanged with devices coupled to the compute device (e.g., the compute device 130 or another device not shown in FIG. 1, via the peer-to-peer communication P) to prove specific verified entitlement(s) are valid leaf(s) in a Merkle tree encoding the verified entitlements 119. In some implementations, the zero-knowledge proofs 117 can be generated by inputting one or more of the verified entitlement, the Merkle leaf associated with the verified entitlement, the DID, the Merkle root, the Merkle path, the proof parameters (e.g., a proving key, verification key, etc.) and/or other data into the ZKP generator. In some implementations, the zero-knowledge proofs 117 can be generated by the hardware token 120 and/or a compute device of an entity (e.g., a server of an issuing entity and/or a verifying entity, not shown in FIG. 1).

The compute device 130 can be functionally and/or structurally similar to the compute device 110. The compute device 130 can be a compute device associated with (e.g., trusting and/or trusted by) an entity (e.g., an authoritative body, a government body, an agency, an organization, a committee, a corporation, and/or the like) different from the entity of the compute device 110. The entity of the compute device 130 can be a cross-entity to the compute device 110, and vice versa. For example, the compute device 110 can be a compute device associated with company D and the compute device 130 can be a compute device associated with company E.

The compute device 130 includes a processor 132, a communication interface 134, and a memory 131. The processor 132 can be structurally and/or functionally similar to the processor 112. The processor 132 can be in communication with the memory 131 via any suitable interconnection, system bus, circuit, and/or the like. The processor can include a trusted execution environment (e.g., Intel SGX, etc.) configured to perform cryptographic operations. As described in further detail herein, the processor 132 can include any number of engines, processing units, cores, etc. configured to execute code, instructions, modules, processes, and/or functions associated with verifying cryptographic structures (e.g. a signed Merkle root 133), generating cryptographic proofs (e.g., zero-knowledge proofs 137) and/or validating cryptographic proofs (e.g., zero-knowledge proofs 117), and exchanging data with devices coupled to the compute device 130 (e.g., the compute device 110 via the peer-to-peer communication P, the hardware token 140, or another device not shown in FIG. 1).

The communication interface 134 can be structurally and/or functionally similar to the communication interface 114. The communication interface 134 can be used to discover nearby devices and establish communications (e.g., peer-to-peer communications) to nearby devices such as the compute device 110, the hardware token 140, or another compute device (not shown in FIG. 1).

The memory 131 can be structurally and/or functionally similar to the memory 111. The memory 131 can include a trusted execution environment (e.g., Intel SGX, etc.) configured to store, for example, sensitive data including cryptographic keys, verified credentials associated with a Merkle tree root, and one or more software modules and/or code that can include instructions that can cause the processor 132 to perform one or more processes, functions, and/or the like (e.g., processes, functions, etc. associated with verifying cryptographic structures (e.g., the signed Merkle root 113), generating cryptographic proofs (e.g., the zero-knowledge proofs 137) and/or validating cryptographic proofs (e.g., the zero-knowledge proofs 117), and exchanging data with devices coupled to the compute device 130 (e.g., the compute device 110 via the peer-to-peer communication P, the hardware token 140, or another device not shown in FIG. 1).

The memory 131 includes the signed Merkle root 133, the verified entitlements 139, the signed public cryptographic key 135, and/or the zero-knowledge proofs 137. The signed Merkle root 133 can be signed by a private cryptographic key of an entity different from the entity of (or associated with) the compute device 110 (e.g., an issuing entity and/or a verifying entity associated with the compute device 110). The signature by the private cryptographic key can be representative of authenticity of the signed Merkle root 133 as recognized by the entity of (or associated with) the compute device 130 (e.g., an issuing entity and/or a verifying entity associated with the compute device 130). The compute device 130 can receive the signed Merkle root 133 113 and/or other data (e.g., Merkle leaves, a Merkle path, proof parameters, etc.) from a compute device (e.g., a server) of the entity of (or associated with) the compute device 130. The data can be used to generate the zero-knowledge proofs 137. The signed Merkle root 133 can be exchanged with devices coupled to the compute device 130 (e.g., the compute device 110 or another device not shown in FIG. 1, via the peer-to-peer communication P) to demonstrate trust among the compute device 130 and the entity of (or associated with) the compute device 130.

In some implementations, the signed Merkle root 133 can expire, such that the compute device 130 may periodically and/or sporadically receive an updated Merkle root including a new signature of the private cryptographic key of the entity of (or associated with) the compute device 130. The signed Merkle root 133 can expire, for example, according to an expiration timestamp defined by the entity of (or associated with) the compute device 130, or according to an update to a revocation list maintained and published by that (or another) entity. The expiration timestamp can be in the range of, for example, one hour, one day, one week, one month, three months, six months, one year or more from issuance of the signed Merkle root 133. In response to receiving a signed Merkle root (e.g., the signed Merkle root 113), the compute device 130 can determine whether the signed Merkle root has expired. In attempting to verify the signature of the signed Merkle root, the compute device 130 can, for example, compare an expiration timestamp of the signature to the current date and/or time. In response to determining the current date and/or time is before the expiration timestamp, the compute device 130 can determine the signature of the signed Merkle root is valid and can subsequently verify the signed Merkle root using a signed public cryptographic key. In response to determining the current date is after the expiration timestamp, the compute device 130 can determine the signature of the signed Merkle root has expired and subsequently the verification fails. In some implementations, the expiration timestamp is also signed by the private key of an entity (e.g., issuing entity and/or verifying entity) to prevent tampering of the expiration timestamp. Accordingly, in such implementations, the expiration timestamp can be verified using the public key of the entity (e.g., the issuing entity and/or verifying entity).

The verified entitlements 139 can be structurally and/or functionally similar to the verified entitlements 119. The verified entitlements 139 can link a DID of the compute device 130 (or a user of the compute device 130) to the signature of the signed Merkle root 133 The verified entitlements 139 and/or data used to generate and/or verify the zero-knowledge proofs 137 (e.g., proof parameters including a proving key, a verification key, etc.) can be issued to the compute device 130 by a compute device (e.g., a server) associated with one or more entities engaging in a trust framework.

The signed public cryptographic key 135 can be a public cryptographic key of a public-private cryptographic key pair of the entity associated with the compute device 130. The signed public cryptographic key 135 can be signed by one or more private cryptographic keys of cross-entities to demonstrate trust among the entity associated with the compute device 130 and the one or more cross-entities. For example, the entity of (or associated with) the compute device 130 can be government body A and the entity of (associated with) the compute device 110 can be government body B. Further, government body A and government body B can be allies sharing sensitive and/or confidential information. The compute device 130 can receive the signed public cryptographic key 135 from the compute device of either entity, or shared by many entities including government body A and government body B. The signed public cryptographic key 135 can be exchanged with devices coupled to the compute device (e.g., the compute device 110 or another device not shown in FIG. 1, via the peer-to-peer communication P) to verify an authenticity of the signed Merkle root 133.

While shown in FIG. 1 as being stored in the memory 131, in some implementations, the signed public cryptographic key 135 can be stored in the hardware token 140. The hardware token 140 can be a secure hardware environment configured to store cryptographic keys, to perform cryptographic operations including generating and/or validating cryptographic proofs, and/or to provide platform-level attestation. The hardware token 140 can be, for example, a YubiKey having a direct connection (e.g., a universal serial bus (USB) connection, etc.) or a wireless coupling (e.g., near-field communication, etc.) to the communication interface 134. The hardware token 140 can be, for example, a security token, or any other suitable hardware-based authenticator. In response to the communication interface 134 initiating the peer-to-peer communication P with a nearby compute device (e.g., the compute device 110 or another device not shown in FIG. 1), the compute device 130 can retrieve the signed public cryptographic key 135 from the hardware token 140 and send the signed public cryptographic key 135 to the nearby compute device. The hardware token 140 can receive input from the user (e.g., input including a hardware switch or button) to generate the zero-knowledge proofs 137 by inputting one or more of the verified entitlement, the Merkle leaf associated with the verified entitlement, the DID, the Merkle root, the Merkle path, the proof parameters (e.g., a proving key, verification key, etc.) and/or other data to a ZKP generator (e.g., zk-SNARK, zk-STARK, Bulletproofs, etc.) of the hardware token 140. In response, the compute device 130 can retrieve the zero-knowledge proofs 137 from the hardware token 140 and send the zero-knowledge proofs 137 to the nearby compute device. In implementations without a hardware token 140, the functions described herein as being performed in the hardware token 140 (e.g., storing the signed public cryptographic key 135 and generating the zero-knowledge proofs 137) can be performed by the processor 132 and memory 131 of the compute device 110. In some implementations, the zero-knowledge proofs 137 can be generated by inputting one or more of the verified entitlement, the Merkle leaf associated with the verified entitlement, the DID, the Merkle root, the Merkle path, the proof parameters (e.g., a proving key, verification key, etc.) and/or other data into the ZKP generator of the hardware token 140.

The zero-knowledge proofs 137 can be a cryptographic proof allowing the compute device 130 to offer proof to another compute device (e.g., the compute device 110 or another compute device not shown in FIG. 1) that the compute device 130 has a verified entitlement, without revealing the full verified entitlement (e.g., the verified entitlements 139). In some implementations, the zero-knowledge proofs 137 can be generated by inputting one or more of the verified entitlement, the Merkle leaf associated with the verified entitlement, the DID, the Merkle root, the Merkle path, the proof parameters (e.g., a proving key, verification key, etc.) and/or other data to a ZKP generator (e.g., zk-SNARK, zk-STARK, Bulletproofs, etc.) of the trusted execution environment of the processor 132. The zero-knowledge proofs 137 can be exchanged with devices coupled to the compute device (e.g., the compute device 110 or another device not shown in FIG. 1, via the peer-to-peer communication P) to prove specific entitlement(s) are valid leaf(s) in a Merkle tree encoding the verified entitlements 119. In some implementations, the zero-knowledge proofs 137 can be generated by inputting one or more of the verified entitlement, the Merkle leaf associated with the verified entitlement, the DID, the Merkle root, the Merkle path, the proof parameters (e.g., a proving key, verification key, etc.) and/or other data into the ZKP generator. In some implementations, the zero-knowledge proofs 117 can be generated by the hardware token 140 and/or a compute device of an entity (e.g., a server, not shown in FIG. 1) and sent to the compute device 130.

In use, the communication interface 114 of the compute device 110 can discover the compute device 130 and can initiate the peer-to-peer communication P with the communication interface 134 of the compute device 130. The compute device 110 and the compute device 130 may not be connected to another network while the peer-to-peer communication P is maintained. For example, the compute device 110 and the compute device 130 can be in a remote environment outside a range of typical Wi-Fi or cellular network coverage. For example, the remote environment can be a mine, a submarine, a spacecraft, and/or any environment with little to no Wi-Fi or cellular network coverage. Through the peer-to-peer communication P, the compute device 130 can verify a verified entitlement of verified entitlements 119 of the compute device 130. For example, the verified entitlement can be an access entitlement associated with a role-based credential. In such an example, the compute device 110 can be a mobile compute device of a user and the compute device 130 can be a site access reader.

In some implementations, the processor 112 can send to the compute device 130 via the peer-to-peer communication P the signed public cryptographic key 115, the signed Merkle root 113, the zero-knowledge proof 117 of a verified entitlement from the verified entitlements 119, and/or a Merkle proof to compute the signed Merkle root 113. The Merkle proof can be a hash path including data associated with the verified entitlement, as discussed in more detail herein with respect to FIG. 3. The signed public cryptographic key 115 can be a public cryptographic key of, for example, entity A, and signed by a private cryptographic key of, for example, entity B. The signed public cryptographic key 115 can represent trust between entity A and entity B. Stated another way, entity A and entity B can share trust in a trust framework.

Prior to sending the zero-knowledge proof 117 of the verified entitlements 119, the processor 112 can generate the zero-knowledge proof 117 using, for example, a ZKP generator of the trusted execution environment of the compute device 110. Where a hardware token is involved, in some implementations a user interacting with the hardware token 120 can cause the hardware token 120 to generate the zero-knowledge proof (rather than the processor 112) via a ZKP generator and send the zero-knowledge proof to the compute device 130. In some implementations, the zero-knowledge proof can be pre-generated or pre-computed (e.g., at a time before initiating the peer-to-peer communication P with the compute device 130, in an environment within range of a network coverage) and can be stored at the memory 111, such as a cache memory. Pre-generation can be advantageous in reducing a battery drain and compute needs of the compute device 110. In some implementations, the zero-knowledge proof 117 can be generated at a compute device other than compute device 110 or hardware token 120. For example, an issuing and/or verifying entity can generate the zero-knowledge proof 117 and send the zero-knowledge proof 117 to the compute device 110 for storage.

In response to receiving the signed public cryptographic key 115 of entity A, the processor 132 can verify that the signed public cryptographic key 115 includes a valid signature by the private cryptographic key of entity B using a public cryptographic key corresponding to the private cryptographic key of entity B (e.g., signed public cryptographic key 135). The signed public cryptographic key 135 can be a public cryptographic key of, for example, entity B, and signed by a private cryptographic key of, for example, entity A. In verifying the signature, the processor 132 can determine that the signature is not expired or has not been revoked, and that entity B trusts entity A.

Further, the processor 132 can verify a signature of the signed Merkle root 113 using the signed public cryptographic key 115 to identify trust of the signed Merkle root 113. The trust can be trust among at least the compute device 110, and, for example, entity A. In doing so, the processor 132 can verify the DID of the user of the compute device 110 and/or the compute device 110, as the signature can be linked to the DID. The signed Merkle root 113 can be signed by the private cryptographic key of, for example, entity A. The signed public cryptographic key 115 is a public cryptographic key of entity A and therefore can be used to verify the signature of the signed Merkle root 113.

Further, the processor 132 can confirm validity of the zero-knowledge proof 117 against the signed Merkle root 113 using a ZKP verifier (e.g., zk-STARK, zk-SNARK, Bulletproofs, etc.). For example, the processor 132 can confirm validity of the zero-knowledge proof 117 by inputting one or more of the verified entitlement, the Merkle leaf associated with the verified entitlement, the DID, the Merkle root, the Merkle path, the proof parameters (e.g., a proving key, verification key, etc.) and/or other data associated with the zero-knowledge proof 117 to a ZKP verifier. For example, in implementations where the ZKP verifier is zk-STARK and/or zk-SNARK, the processor 132 can use a verifying key of the compute device 130 to confirm validity of the zero-knowledge proof 117.

Further, the processor 132 can select, in response to confirming validity of the zero-knowledge proof 117, data to send to the compute device 110 based on the zero-knowledge proof 117 of the compute device 110. For example, the processor 132 can send a quick-response (QR) code associated with accessing a site of entity A to the compute device 110 to enable the compute device 110 (or a user of the compute device 110) to access the site.

In an alternative example, the compute device 110 can be a compute device of a user with a verified entitlement to control a resource associated with the compute device 130 (or another compute device not shown in FIG. 1). The resource can be or include, for example, an artificial intelligence (AI) agent, a drone, a vehicle, a robot, a maritime vessel, a spacecraft, a satellite, a power grid, a traffic management system, a smart building, a cloud server, a virtual machine, a medical device, etc. In an alternative example, the compute device 130 can be included in a drone. The compute device 130 can verify the drone control privilege received from the compute device 110 and in response the compute device 130 can select data to send to the compute device 110 to permit the compute device 110 to take control of the drone. In such an example, the user-drone interaction can take place at a power distribution facility outside a satellite coverage, wherein the user can control the drone to inspect high-voltage lines from a safe distance.

While described above as the compute device 130 verifying an entitlement of the compute device 110, it can be appreciated that the compute device 110 can reciprocally verify an entitlement (e.g., verified entitlements 139) of the compute device 130 in a similar process. In such instances, the communication interface 134 of the compute device 130 can discover the compute device 110 and can initiate the peer-to-peer communication P with the communication interface 114 of the compute device 110.

In some implementations, the compute device 110 and compute device 130 can exchange data in a reciprocal transaction to verify each other's entitlements. In some such implementations, the compute device 110 and the compute device 130 can share cryptographic data used to verify each other's entitlements in parallel or at a substantially similar time. More specifically, the compute device 110 can send to the compute device 130 the signed public cryptographic key 115, the signed Merkle root 113, the zero-knowledge proofs 117, and/or data associated with the verified entitlements 119 to offer proof of a verified entitlement to the compute device 130. Meanwhile, the compute device 130 can send to the compute device 110 the signed public cryptographic key 135, the signed Merkle root 133, the zero-knowledge proofs 137, and/or data associated with the verified entitlements 139 to offer proof of a verified entitlement to the compute device 110. In some such implementations, the verified entitlements 119 and the verified entitlements 139 can be associated with role-based credentials for two users engaged in a joint operation. For example, the user-user interaction can take place during an emergency response effort such as a natural disaster or public event, wherein users of different entities desire to coordinate and share resources in an environment with limited or no network (e.g., cellular network, etc.) coverage.

In some implementations, the processor 132 can use the Merkle path of the compute device 110 to compute the signed Merkle root 113, thereby confirming the entitlement exists in a Merkle tree including the Merkle root 113. In doing so, the processor 132 can confirm validity of the zero-knowledge proof 117. For example, the processor 132 can compute a hash using the Merkle path and confirm the hash is the signed Merkle root 113, as described in further detail with respect to an alternative implementation in FIG. 3. In some implementations, the processor 132 does not compute the signed Merkle root 113 using the Merkle path and instead verifies the zero-knowledge proof 117 using a ZKP verifier (e.g., zk-STARK, zk-SNARK, Bulletproofs, etc.).

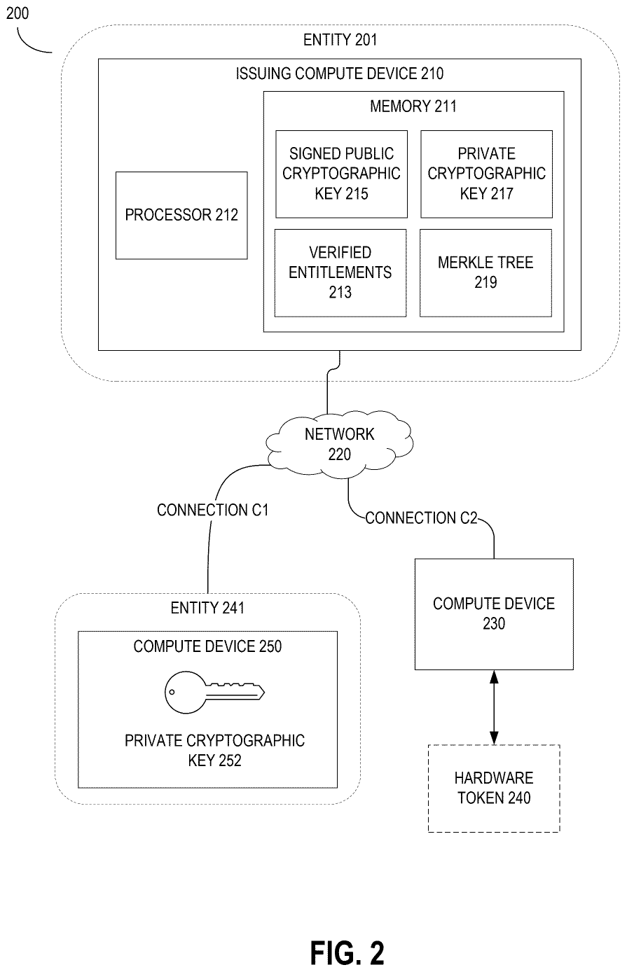

FIG. 2 shows a system block diagram of a cryptographic credential distribution system 200, according to an embodiment. The cryptographic credential distribution system 200 can be a system for distributing verified entitlements to compute devices. The cryptographic credential distribution system 200 includes network 220, issuing compute device 210, compute device 250, compute device 230, and hardware token 240.

The network 220 can be any type of network(s) such as, for example, a local area network (LAN), a wireless local area network (WLAN), a wide area network (WAN), a metropolitan area network (MAN), a worldwide interoperability for microwave access network (WiMAX), a telephone network (such as the Public Switched Telephone Network (PSTN) and/or a Public Land Mobile Network (PLMN)), an intranet, the Internet, an optical fiber (or fiber optic)-based network, a cellular network, and/or any other suitable network. The network can include various configurations and protocols, including, for example, short range communication protocols, Bluetooth®, Bluetooth® LE, the Internet, World Wide Web, intranets, virtual private networks, wide area networks, local networks, private networks using communication protocols proprietary to one or more companies, Ethernet, Wi-Fi® and/or Hypertext Transfer Protocol (HTTP), cellular data networks, satellite networks, free space optical networks and/or various combinations of the foregoing. Such communication can be facilitated by any device capable of transmitting data to and from other compute devices, such as a modem(s) and/or a wireless interface(s). The network 220 can be communicatively coupled to the issuing compute device 210, the compute device 250, and/or the compute device 230.

The issuing compute device 210 can be, for example, a personal computer (PC), a workstation, a server, or a group of servers of the entity 201. The entity 201 can be, for example, an authoritative body, a government body, an agency, an organization, a committee, a corporation, and/or the like. In some implementations, the issuing compute device 210 can generate the verified entitlements 213 of the compute device 230 (or other compute devices not shown in FIG. 2). In some implementations, the issuing compute device 230 can receive the verified entitlements 213 from other third-parties and aggregate the entitlements from the various third-parties (e.g., into a Merkle tree). The issuing compute device 210 can send the verified entitlements 213 and other cryptographic data (e.g., proof parameters to generate/verify ZKP's of the verified entitlements 213, a Merkle root, a Merkle path, etc.) to the compute device 230 via the network 220. The issuing compute device 210 includes a processor 212 and a memory 211.

In some implementations, the issuing compute device 210 can maintain a cryptographic accumulator of the verified entitlements 213 of the compute device 230 or verified entitlement of other compute devices associated with the entity 201 (not shown in FIG. 2). The issuing compute device 210 can revoke an entitlement of the compute device 230 by removing the entitlement from the cryptographic accumulator.

The processor 212 can be structurally similar to the processor 112 of FIG. 1. The processor 212 can be in communication with the memory 211 via any suitable interconnection, system bus, circuit, and/or the like. As described in further detail herein, the processor 212 can include any number of engines, processing units, cores, etc. configured to execute code, instructions, modules, processes, and/or functions associated with generating cryptographic keys, initializing decentralized identifiers, exchanging data with compute devices of other entities (e.g., the compute device 250 of entity 241), generating and/or verifying entitlements of a compute device (e.g., the compute device 230), building a Merkle tree of verified entitlements, generating zero-knowledge proofs, and/or sending cryptographic data to the compute device (e.g., the compute device 230).

The memory 211 can be structurally similar to the memory 111 of FIG. 1. The memory 211 can be configured to store data (e.g., cryptographic data), and one or more software modules and/or code that can include instructions that can cause the processor 212 to perform one or more processes, functions, and/or the like (e.g., processes, functions, etc. associated with generating cryptographic keys, initializing decentralized identifiers, exchanging data with compute devices of other entities (e.g., the compute device 250 of entity 241), generating and/or verifying entitlements of a compute device (e.g., the compute device 230), building a Merkle tree of verified entitlements, generating zero-knowledge proofs, and/or sending cryptographic data to the compute device (e.g., the compute device 230)). The memory 211 includes verified entitlements 213, a signed public cryptographic key 215, a private cryptographic key 217, and a Merkle tree 219.

The signed public cryptographic key 215 and private cryptographic key 217 can be a public-private key pair of the entity 201. The signed public cryptographic key 215 can be signed by one or more private cryptographic key(s) of different entities (e.g., the entity 241, or other entities not shown in FIG. 2). The signature of the signed public cryptographic key 215 can represent trust among entities in a trust framework (e.g., trust among at least entity 201 and entity 241). For example, the entities can be allies, partners, or collaborators desiring to prove trust among operators of the entities.

The Merkle tree 219 can be structurally and/or functionally similar to the Merkle tree described in FIG. 1. The Merkle tree 219 can be used to encode the verified entitlements 213 associated with the compute device 230. Each leaf node of the Merkle tree 219 can be a hash of a verified entitlement, or a hash of a decentralized identifier and the verified entitlement from the verified entitlements 213. The Merkle root of the Merkle tree 219 can be signed by the private cryptographic key 217 to represent an authenticity of the Merkle root as recognized by the entity 201. The verified entitlements 213 can be structurally and/or functionally similar to the verified entitlements 119 of FIG. 1. The verified entitlements 213 can link a DID of a user and/or the compute device 230 to the signature of the Merkle root of the Merkle tree 219.

The entity 241 can be, for example, an authoritative body, a government body, an agency, an organization, a committee, a corporation, and/or the like engaged in a trust framework with the entity 201. The compute device 250 can be any suitable hardware configured to store the private cryptographic key 252. The private cryptographic key 252 and a public cryptographic key (not shown in FIG. 2) of the compute device 250 can be a public-private key pair of the entity 241. In response to receiving a public cryptographic key of another entity (e.g., the entity 201 via connection C1 to the network 220, or another entity not shown in FIG. 2), the compute device 250 can sign the public cryptographic key using the private cryptographic key 252 to produce a signed public cryptographic key (e.g., the signed public cryptographic key 215). The signature can represent trust among entities in a trust framework (e.g., trust among at least entity 201 and entity 241).

The compute device 230 can be structurally and/or functionally similar to the compute device 110 and/or the compute device 130 of FIG. 1. The compute device 230 can receive the verified entitlements 213, data associated with the verified entitlements 213 (e.g., hashes of the Merkle tree 219, zero-knowledge proofs for entitlements in the Merkle tree 219 (not shown in FIG. 2), etc.), a signed Merkle root of the Merkle tree 219, and/or the signed public cryptographic key 215 from the issuing compute device 210 via connection C2 to the network 220.

The hardware token 240 can be structurally and/or functionally similar to the hardware token 120 and/or the hardware token 140 of FIG. 1. In some implementations, the compute device 230 can receive the signed public cryptographic key 215 from the issuing compute device 210 and store the signed public cryptographic key 215 in the hardware token 240. The hardware token 240 can be a secure hardware environment configured to store cryptographic keys, to perform cryptographic operations including generating and/or validating cryptographic proofs, and/or to provide platform-level attestation. In implementations without a hardware token 240, the functions performed in the hardware token 240 (e.g., storing the signed public cryptographic key 215 and generating zero-knowledge proofs) can be performed by a processor (e.g., functionally similar to the processor 112 of FIG. 1, not shown in FIG. 2) and a memory (e.g., functionally similar to the memory 111 of FIG. 1, not shown in FIG. 2) of the compute device 230.

In use, two entities can establish a trust framework by signing each other's public cryptographic keys. The compute device 250 can be communicatively coupled to the network 220 via connection C1. The issuing compute device 210 can send a public cryptographic key of a public-private cryptographic key pair to the compute device 250 via the network 220. In response to receiving the public cryptographic key, the compute device 250 can sign the public cryptographic key using the private cryptographic key 252 to produce the signed public cryptographic key 215. The issuing compute device 210 can receive the signed public cryptographic key 215 from the compute device 250 and can store the signed public cryptographic key 215 at the memory 211 for further use.

The compute device 230 can be communicatively coupled to the network 220 via connection C2. The issuing compute device 210 can produce and assign the verified entitlements 213 based on a decentralized identifier of the compute device 230. For example, the issuing compute device 210 can generate and maintain a registry of entitlement sets for many decentralized identifiers of compute devices in a trust framework. The issuing compute device 210 can also maintain a revocation status for each entitlement of the entitlement sets, in, for example, a cryptographic accumulator.

The issuing compute device 210 can build the Merkle tree 219 by hashing the verified entitlements and/or the decentralized identifier and sign the Merkle root of the Merkle tree using the private cryptographic key 217 to produce a signed Merkle root (e.g., the signed Merkle root 113 of FIG. 1). The issuing compute device 210 can supply a timestamp to the signature of the signed Merkel root to indicate an expiration of the signed Merkle root, after which the signed Merkle root will be invalid. The issuing compute device 210 can revoke the signed Merkle root and/or a verified entitlement 213 prior to the expiration timestamp.

The issuing compute device 210 can send the signed public cryptographic key 215, the verified entitlements 213, the signed Merkle root of the Merkle tree 219, other data from the Merkle tree (e.g., Merkle leaves, a Merkle path etc.), and/or proof parameters (e.g., a proving key, a verifying key, etc.) to the compute device 230 while the connection C2 is maintained. The compute device 230 can store the signed public cryptographic key 215, the verified entitlements 213, the signed Merkle root of the Merkle tree 219, the other data from the Merkle tree, and/or the proof parameters at a memory including a trusted execution environment of the compute device 230 (not shown in FIG. 2) for use at a later time. In implementations where the hardware token 240 is used, the hardware token 240 can store the proof parameters, the other data from the Merkle tree, the signed public cryptographic key 215 and/or the verified entitlements 213.

In response to an expiration of the signed Merkle root, the compute device 230 can re-establish connection C2 to the network 220 to receive an updated Merkle root (and/or updated other data) from the issuing compute device 210. The compute device 230 can send the decentralized identifier to the issuing compute device 210. The issuing compute device 230 can re-sign the Merkle root with the private cryptographic key 217 to produce the updated Merkle root and can send the updated Merkle root to the compute device 230. In some implementations, in response to receiving the decentralized identifier, the issuing compute device 210 can re-verify the entitlements of the compute device 230 to produce updated entitlements and can generate a new Merkle tree of the updated entitlements. The issuing compute device 210 can sign the Merkle root of the new Merkle tree with the private cryptographic key 217 to produce a new signed Merkle root and can send the new signed Merkle root to the compute device 230.

In some implementations, the compute device 230 can submit relevant entitlements to a verifying compute device (not shown in FIG. 2). In some implementations, the issuing compute device 210 can also be a verifying compute device. The verifying compute device can verify the relevant entitlements of the compute device 230 (or another compute device, not shown in FIG. 2) to produce verified entitlements for one or more compute devices. In some such implementations, the compute device 230 can initialize and provide a decentralized identifier to the verifying compute device. In some such implementations, the verifying compute device can deny an entitlement sent by the compute device 230 when, for example, the entitlement is associated with a credential other than a credential of the compute device 230. For example, the compute device 230 can be a compute device of a nurse and the compute device 230 can (inadvertently or otherwise) submit entitlements associated with a doctor. In such an example, the verifying compute device can determine the entitlements cannot be verified because the compute device 230 does not have the associated credential. In response, in some implementations, the verifying compute device can send a signal to the compute device 230 indicating that the entitlement may not be verified.

FIG. 3 shows a diagram of an example Merkle tree 300, according to an embodiment. The Merkle tree 300 can be structurally and/or functionally similar to the Merkle tree 219 of FIG. 2. The Merkle tree 300 can be generated by an issuing compute device of an entity (e.g., the issuing compute device 210 of FIG. 2, not shown in FIG. 3). The Merkle tree 300 includes Merkle root 302, and Data A-F. Data A-F can be associated with verified entitlements E_{A}, E_{B}, E_{c}, and E_{D} of a compute device (not shown in FIG. 3) recognized by the entity.

Data A can be a hash of a username (e.g., a decentralized identifier (DID)) and/or an entitlement E_{A} of a compute device (not shown in FIG. 3). Similarly, data B can be a hash of the username and/or an entitlement E_{B} of the compute device. Similarly, data C can be a hash of the username and/or an entitlement E_{C} of the compute device. Similarly, data D can be a hash of the username and/or an entitlement E_{D} of the compute device. Data E can be a hash of data A and data B. Data F can be a hash of data C and data D. The Merkle root 302 can be a hash of data E and data F.

In use, an issuing compute device of an entity can construct the Merkle tree 300 using a username (e.g., a DID) and verified entitlements E_{A}, E_{B}, E_{C}, and E_{D} of an associated compute device. The issuing compute device can send the Merkle root 302 and/or other data from the Merkle tree 300 to the associated compute device. The other data can be and/or include a hash path (e.g., Merkle proof) including at least one of Data A-F, proof parameters, and/or the like. The associated compute device can store and exchange the Merkle root 302 to prove at least one of the entitlements E_{A}, E_{B}, E_{C}, and E_{D} to another compute device in a peer-to-peer engagement.

In some implementations, for example, the associated compute device can send the signed Merkle root 302, a ZKP and proof parameters with another compute device. The other compute device can input the Merkle root 302, the ZKP and/or proof parameters to a ZKP verifier (e.g., zk-SNARK, zk-STARK, Bulletproofs, etc.) to verify the ZKP. In such implementations, the Merkle proof is not sent to the other compute device and the other compute device does not independently compute the Merkle root 302.

While shown and described in FIG. 3 as being a Merkle tree of four entitlements E_{A}, E_{B}, E_{C}, and E_{D}, and thereby referred to herein as being a size four Merkle tree, the Merkle tree 300 can be a Merkle tree of any size. In some implementations, the Merkle tree 300 can be a Merkle tree of size one, where the Merkle root 302 is a hash of the username and/or an entitlement E_{E}. In some other implementations, the Merkle tree 300 can be a Merkle tree of size two, where the Merkle root 302 is a hash of a data G and a data H, data G being a hash of the username and/or an entitlement E_{F} and data H being a hash of the username and/or an entitlement E_{G}.

In some implementations, for example, device one (e.g., the compute device 110 of FIG. 1) can have verified entitlements E_{A}, E_{B}, E_{C}, and E_{D} and can desire to prove verified entitlement E_{B} to device two (e.g., the compute device 130 of FIG. 1). The Merkle proof for entitlement E_{B} may be a hash path including Data A, Data B, and Data F. Device one can send the Merkle root 302 and a signed public cryptographic key (e.g., the signed public cryptographic key 115 of FIG. 1) to device two. Device one can send a zero-knowledge proof of verified entitlement E_{B}, as well as Data A, Data B, and Data F to device two so that device two can compute the Merkle root 302. Device two can compute a hash of Data A and Data B to get Data E and then compute a hash of Data E and Data F to get the Merkle root 302. Device two can confirm the entitlement E_{B} is part of the Merkle tree 300 based on the Merkle root 302. Specifically, device two can ensure that the Merkle root 302 received from device one equals the Merkle root computed using the hash path and entitlement data provided by device one. Therefore, device two can confirm validity of the zero-knowledge proof.

In some implementations, Data A-D can be hashes of the username and/or a zero-knowledge proof of the entitlements. For example, Data A can be a hash of the username and a zero-knowledge proof of entitlement E_{A}. In some implementations, an issuing and/or verifying compute device (e.g., the issuing compute device 210 of FIG. 2) can generate the zero-knowledge proofs for each entitlement E_{A}, E_{B}, E_{C}, and E_{D}. In some implementations, a compute device (e.g., the compute device 230 of FIG. 2) can generate the zero-knowledge proofs for each entitlement E_{A}, E_{B}, E_{C}, and E_{D} and submit them to the issuing and/or verifying compute device. In some implementations, the compute device may not store the entitlements E_{A}, E_{B}, E_{C}, and E_{D} on-device. In some implementations, a first compute device (e.g., the compute device 110 of FIG. 1) can, via a peer-to-peer communication, offer proof of one of the entitlements E_{A}, E_{B}, E_{C}, and E_{D} to a second compute device (e.g., the compute device 130 of FIG. 1). For example, to verify entitlement E_{D}, the first compute device can send the Merkle root 302, a zero-knowledge proof of E_{D}, a DID, Data C, and Data E to the second compute device. The second compute device can compute a hash of the zero-knowledge proof and the DID to obtain Data D. The second compute device can compute a hash of Data C and Data D to obtain Data F. The second compute device can compute a hash of Data E and Data F to obtain the Merkle root 302. The second compute device can compare the calculated Merkle root 302 with the Merkle root 302 provided by the first compute device to determine the Merkle roots are equal. The second compute device can thereby confirm the first compute device has the entitlement E_{D}, and in doing so can confirm the validity of the zero-knowledge proof.

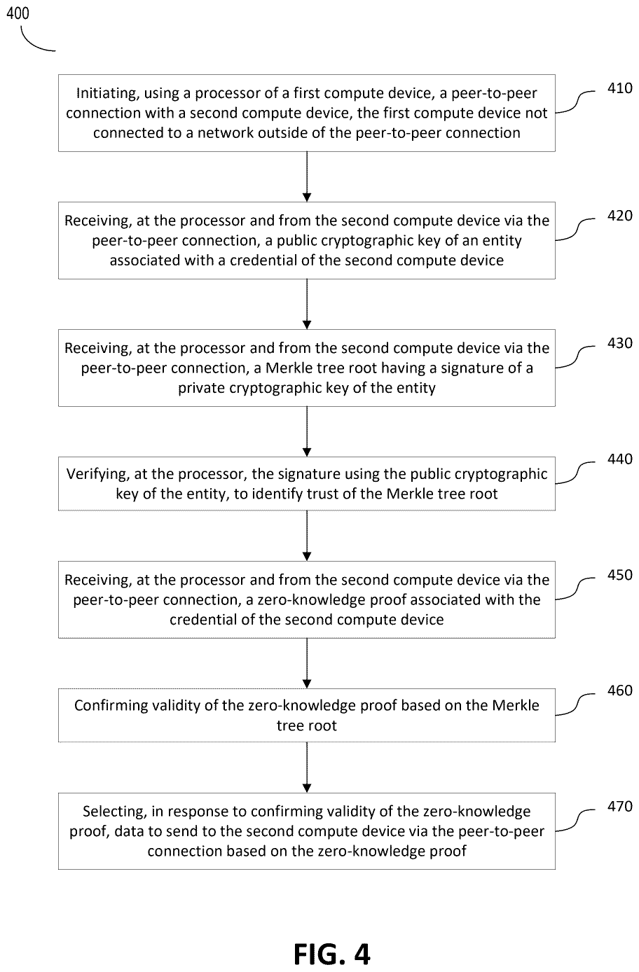

FIG. 4 shows an example method 400 for offline cryptographic verification, according to an embodiment. The method 400 can be implemented by compute device(s) of an offline cryptographic verification system (e.g., the offline cryptographic verification system 100 of FIG. 1). The method 400 can be stored as instructions and/or one or more software modules at a memory (e.g., the memory 111 of FIG. 1) and implemented by a processor (e.g., the processor 112 of FIG. 1).

At 410, the method 400 includes initiating, using a processor of a first compute device, a peer-to-peer connection with a second compute device (e.g., the compute device 130 of FIG. 1), the first compute device not connected to a network outside of the peer-to-peer connection.

At 420, the method 400 includes receiving, at the processor and from the second compute device via the peer-to-peer connection, a public cryptographic key of an entity associated with a credential of the second compute device.

At 430, the method 400 includes receiving, at the processor and from the second compute device via the peer-to-peer connection, a Merkle tree root having a signature of a private cryptographic key of the entity.

At 440, the method 400 includes verifying, at the processor, the signature using the public cryptographic key of the entity, to identify trust of the Merkle tree root.

At 450, the method 400 includes receiving, at the processor and from the second compute device via the peer-to-peer connection, a zero-knowledge proof associated with the credential of the second compute device.

At 460, the method 400 includes confirming validity of the zero-knowledge proof based on the Merkle tree root. Confirming validity can include confirming validity using a ZKP verifier (e.g., zk-SNARK, zk-STARK, Bulletproofs, etc.).

At 470, the method 400 includes selecting, in response to confirming validity of the zero-knowledge proof, data to send to the second compute device via the peer-to-peer connection based on the zero-knowledge proof.

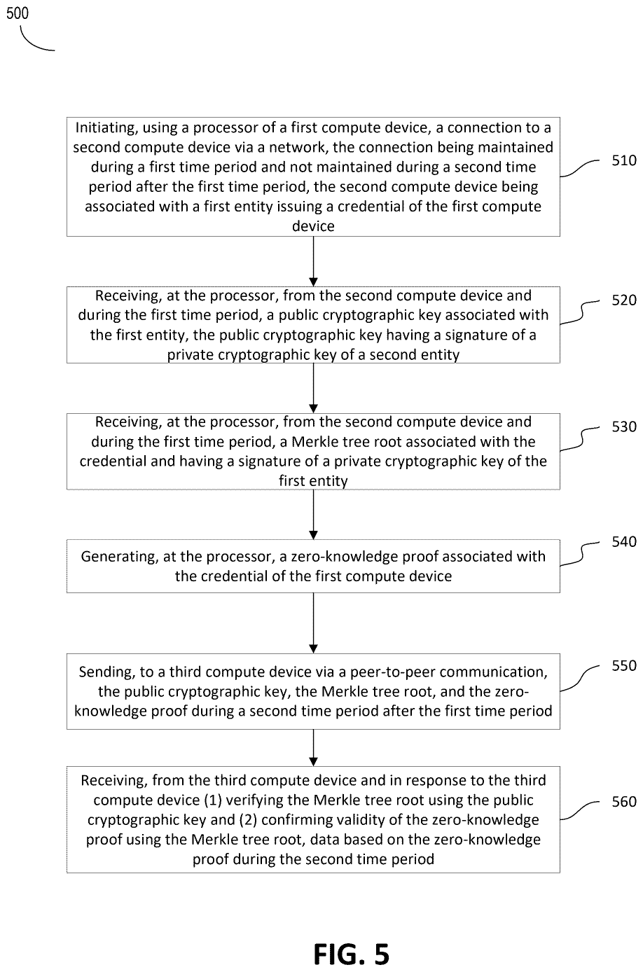

FIG. 5 shows an example method 500 for cryptographic credential distribution and offline cryptographic verification, according to an embodiment. The method 500 can be implemented by an offline cryptographic verification system (e.g., the offline cryptographic verification system 100 of FIG. 1) and/or an offline cryptographic credential distribution system (e.g., the cryptographic credential distribution system 200 of FIG. 2). The method 500 can be stored as instructions and/or one or more software modules at a memory (e.g., the memory 111 of FIG. 1) and implemented by a processor (e.g., the processor 112 of FIG. 1).

At 510, the method 500 includes initiating, using a processor of a first compute device, a connection to a second compute device via a network, the connection being maintained during a first time period and not maintained during a second time period after the first time period, the second compute device (e.g., the issuing compute device 210 of FIG. 2) being associated with a first entity issuing a credential of the first compute device.

At 520, the method 500 includes receiving, at the processor, from the second compute device and during the first time period, a public cryptographic key associated with the first entity (e.g., the signed public cryptographic key 215 of FIG. 2), the public cryptographic key having a signature of a private cryptographic key of a second entity (e.g., the private cryptographic key 252 of FIG. 2).

At 530, the method 500 includes receiving, at the processor, from the second compute device and during the first time period, a Merkle tree root associated with the credential and having a signature of a private cryptographic key of the first entity (e.g., the private cryptographic key 217 of FIG. 2).

At 540, the method 500 includes generating, at the processor, a zero-knowledge proof (e.g., the zero-knowledge proof 117 of FIG. 1) associated with the credential of the first compute device.

At 550, the method 500 includes sending, to a third compute device via a peer-to-peer communication, the public cryptographic key (e.g., the signed public cryptographic key 115 of FIG. 1), the Merkle tree root (e.g., the signed Merkle root 113 of FIG. 1), and the zero-knowledge proof during a second time period after the first time period.

At 560, the method 500 includes receiving, from the third compute device and in response to the third compute device (1) verifying the Merkle tree root using the public cryptographic key and (2) confirming validity of the zero-knowledge proof using the Merkle tree root, data based on the zero-knowledge proof during the second time period.

While shown and described herein as generating and verifying ZKPs, in some implementations any other cryptographic proof (e.g., verifiable credential, etc.) can be generated and/or verified. For example, a compute device (e.g., compute device 110, issuing compute device 210, etc.) can generate a verifiable credential and send the verifiable credential to another compute device (e.g., compute device 130) to be verified using the methods and/or processes described herein.

In some embodiments, a method comprises: initiating, using a processor of a first compute device, a peer-to-peer communication with a second compute device, the first compute device not connected to a network outside of the peer-to-peer communication; receiving, at the processor and from the second compute device via the peer-to-peer communication, a public cryptographic key of an entity associated with a credential of the second compute device; receiving, at the processor and from the second compute device via the peer-to-peer communication, a Merkle tree root having a signature of a private cryptographic key of the entity; verifying, at the processor, the signature using the public cryptographic key of the entity, to identify trust of the Merkle tree root; receiving, at the processor and from the second compute device via the peer-to-peer communication, a zero-knowledge proof associated with the credential of the second compute device; confirming validity of the zero-knowledge proof based on the Merkle tree root; and selecting, in response to confirming validity of the zero-knowledge proof, data to send to the second compute device via the peer-to-peer communication based on the zero-knowledge proof.

In some such implementations, the entity is a first entity, the public cryptographic key of the first entity is signed by a private cryptographic key of a second entity, the first compute device storing a public cryptographic key of the second entity.

In some such implementations, the method further comprises: restricting, before confirming validity of the zero-knowledge proof, the processor of the first compute device from sending the data to the second compute device via the peer-to-peer communication.

In some such implementations, the second compute device is a mobile compute device and the credential is an access entitlement.

In some such implementations, the signature has a predetermined expiration.

In some such implementations, the data includes an indication for the second compute device to take control of the first compute device, the method further comprising: receiving, at the processor and from the second compute device via the peer-to-peer communication, a plurality of instructions; and executing, at the processor, the plurality of instructions.

In some such implementations, the second compute device includes a hardware token configured to (1) generate a plurality of zero-knowledge proofs, each zero-knowledge proof being associated with a credential from a plurality of credentials of the second compute device, and (2) store the public cryptographic key.

In some such implementations, the Merkle tree root is a root node of a Merkle tree having a plurality of leaf nodes, each leaf node from the plurality of leaf nodes being associated with a credential from a plurality of credentials of the second compute device.

In some embodiments, a non-transitory, processor-readable medium stores instructions that, when executed by a processor, cause the processor to: initiate, with a first compute device, a peer-to-peer communication with a second compute device, the first compute device not connected to a network outside of the peer-to-peer communication; send, to the second compute device via the peer-to-peer communication, a public cryptographic key of a first entity, the public cryptographic key of the first entity being signed by a private cryptographic key of a second entity; send, to the second compute device via the peer-to-peer communication, a first Merkle tree root signed by the private cryptographic key of the first entity; receive, from the second compute device via the peer-to-peer communication, a public cryptographic key of the second entity, the public cryptographic key of the second entity being signed by a private cryptographic key of the first entity; receive, from the second compute device via the peer-to-peer communication, a second Merkle tree root signed by the private cryptographic key of the second entity; verify a signature of the second Merkle tree root using the public cryptographic key of the second entity, to identify trust of the second Merkle tree root; receive, from the second compute device via the peer-to-peer communication, a first zero-knowledge proof associated with a credential of the second compute device; confirm validity of the first zero-knowledge proof based on the second Merkle tree root; send, to the second compute device via the peer-to-peer communication, a second zero-knowledge proof associated with a credential of the first compute device; select, in response to confirming validity of the first zero-knowledge proof, data to send to the second compute device via the peer-to-peer communication based on the first zero-knowledge proof; and receive, data from the second compute device via the peer-to-peer communication based on the second zero-knowledge proof.

In some such implementations, the first Merkle tree root is a root node of a Merkle tree having a plurality of leaf nodes, each leaf node from the plurality of leaf nodes being associated with a credential from a plurality of credentials of the first compute device, and the second Merkle tree root is a root node of a Merkle tree having a plurality of leaf nodes, each leaf node from the plurality of leaf nodes being associated with a credential from a plurality of credentials of the second compute device.

In some such implementations, the non-transitory, processor-readable medium further stores instructions that, when executed by a processor, cause the processor further to: generate, before initiating the peer-to-peer communication with the second compute device, the second zero-knowledge proof; and store the second zero-knowledge proof in a cache memory of the first compute device.

In some such implementations, the first compute device and the second compute device are mobile compute devices, and the credential of the first compute device and the credential of the second compute device are role-based credentials.

In some such implementations, the first compute device includes a hardware token configured to store a plurality of cryptographic keys including the public cryptographic key of the first entity and the public cryptographic key of the second entity.

In some embodiments, a method comprises: initiating, using a processor of a first compute device, a connection to a second compute device via a network, the connection being maintained during a first time period and not maintained during a second time period after the first time period, the second compute device being associated with a first entity issuing a credential of the first compute device; receiving, at the processor, from the second compute device and during the first time period, a public cryptographic key associated with the first entity, the public cryptographic key having a signature of a private cryptographic key of a second entity; receiving, at the processor, from the second compute device and during the first time period, a Merkle tree root associated with the credential and having a signature of a private cryptographic key of the first entity; generating, at the processor, a zero-knowledge proof associated with the credential of the first compute device; sending, to a third compute device via a peer-to-peer communication, the public cryptographic key, the Merkle tree root, and the zero-knowledge proof during a second time period after the first time period; and receiving, from the third compute device and in response to the third compute device (1) verifying the Merkle tree root using the public cryptographic key and (2) confirming validity of the zero-knowledge proof using the Merkle tree root, data based on the zero-knowledge proof during the second time period.

In some such implementations, the Merkle tree root is a first Merkle tree root, the connection is a first connection, the peer-to-peer communication is maintained during the second time period and not at a third time period after the second time period, the method further comprising: initiating, using the processor, a second connection to the second compute device via the network in response to an expiration of the signature of the private cryptographic key of the first entity, the second connection being maintained during the third time period; receiving, at the processor via the network and during the third time period, a second Merkle tree root having an updated signature of the private cryptographic key of the first entity; and storing the second Merkle tree root in a cache memory of the first compute device.

In some such implementations, the second compute device is a server, the first compute device is a mobile compute device and the credential is an access entitlement.

In some such implementations, the zero-knowledge proof is generated by a hardware token of the first compute device.

In some such implementations, the Merkle tree root is a root node of a Merkle tree of a plurality of leaf nodes, each node from the plurality of leaf nodes associated with a credential from a plurality of credentials of the first compute device.

In some such implementations, the data allows the first compute device to take control of the third compute device, the method further comprising: sending, from the processor and to the third compute device via the peer-to-peer communication, a plurality of instructions such that the third compute device executes the plurality of instructions.

In some such implementations, the peer-to-peer communication is at least one of a Bluetooth Low Energy (BLE) communication, a Wi-Fi ad hoc communication or a radio communication.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™M, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A method, comprising:
initiating, using a processor of a first compute device, a peer-to-peer communication with a second compute device, the first compute device not connected to a network outside of the peer-to-peer communication;
receiving, at the processor and from the second compute device via the peer-to-peer communication, a public cryptographic key of an entity associated with a credential of the second compute device;
receiving, at the processor and from the second compute device via the peer-to-peer communication, a Merkle tree root having a signature of a private cryptographic key of the entity;
verifying, at the processor, the signature using the public cryptographic key of the entity, to identify trust of the Merkle tree root;
receiving, at the processor and from the second compute device via the peer-to-peer communication, a zero-knowledge proof associated with the credential of the second compute device;
confirming validity of the zero-knowledge proof based on the Merkle tree root; and
selecting, in response to confirming validity of the zero-knowledge proof, data to send to the second compute device via the peer-to-peer communication based on the zero-knowledge proof.

2. The method of claim 1, wherein the entity is a first entity, the public cryptographic key of the first entity is signed by a private cryptographic key of a second entity, the first compute device storing a public cryptographic key of the second entity.

3. The method of claim 1, further comprising:
restricting, before confirming validity of the zero-knowledge proof, the processor of the first compute device from sending the data to the second compute device via the peer-to-peer communication.

4. The method of claim 1, wherein the second compute device is a mobile compute device and the credential is an access entitlement.

5. The method of claim 1, wherein the signature has a predetermined expiration.

6. The method of claim 2, wherein the data includes an indication for the second compute device to take control of the first compute device, the method further comprising:
receiving, at the processor and from the second compute device via the peer-to-peer communication, a plurality of instructions; and
executing, at the processor, the plurality of instructions.

7. The method of claim 1, wherein the second compute device includes a hardware token configured to (1) generate a plurality of zero-knowledge proofs, each zero-knowledge proof being associated with a credential from a plurality of credentials of the second compute device, and (2) store the public cryptographic key.

8. The method of claim 1, wherein the Merkle tree root is a root node of a Merkle tree having a plurality of leaf nodes, each leaf node from the plurality of leaf nodes being associated with a credential from a plurality of credentials of the second compute device.

9. A non-transitory, processor-readable medium storing instructions that, when executed by a processor, cause the processor to:
initiate, with a first compute device, a peer-to-peer communication with a second compute device, the first compute device not connected to a network outside of the peer-to-peer communication;
send, to the second compute device via the peer-to-peer communication, a public cryptographic key of a first entity, the public cryptographic key of the first entity being signed by a private cryptographic key of a second entity;
send, to the second compute device via the peer-to-peer communication, a first Merkle tree root signed by the private cryptographic key of the first entity;
receive, from the second compute device via the peer-to-peer communication, a public cryptographic key of the second entity, the public cryptographic key of the second entity being signed by a private cryptographic key of the first entity;
receive, from the second compute device via the peer-to-peer communication, a second Merkle tree root signed by the private cryptographic key of the second entity;
verify a signature of the second Merkle tree root using the public cryptographic key of the second entity, to identify trust of the second Merkle tree root;
receive, from the second compute device via the peer-to-peer communication, a first zero-knowledge proof associated with a credential of the second compute device;
confirm validity of the first zero-knowledge proof based on the second Merkle tree root;
send, to the second compute device via the peer-to-peer communication, a second zero-knowledge proof associated with a credential of the first compute device;
select, in response to confirming validity of the first zero-knowledge proof, data to send to the second compute device via the peer-to-peer communication based on the first zero-knowledge proof; and
receive, data from the second compute device via the peer-to-peer communication based on the second zero-knowledge proof.

10. The non-transitory, processor-readable medium of claim 9, wherein the first Merkle tree root is a root node of a Merkle tree having a plurality of leaf nodes, each leaf node from the plurality of leaf nodes being associated with a credential from a plurality of credentials of the first compute device, and the second Merkle tree root is a root node of a Merkle tree having a plurality of leaf nodes, each leaf node from the plurality of leaf nodes being associated with a credential from a plurality of credentials of the second compute device.

11. The non-transitory, processor-readable medium of claim 9 further storing instructions that, when executed by a processor, cause the processor to:
generate, before initiating the peer-to-peer communication with the second compute device, the second zero-knowledge proof; and
store the second zero-knowledge proof in a cache memory of the first compute device.

12. The non-transitory, processor-readable medium of claim 9, wherein the first compute device and the second compute device are mobile compute devices, and the credential of the first compute device and the credential of the second compute device are role-based credentials.

13. The non-transitory, processor-readable medium of claim 9, wherein the first compute device includes a hardware token configured to store a plurality of cryptographic keys including the public cryptographic key of the first entity and the public cryptographic key of the second entity.

14. A method, comprising:
initiating, using a processor of a first compute device, a connection to a second compute device via a network, the connection being maintained during a first time period and not maintained during a second time period after the first time period, the second compute device being associated with a first entity issuing a credential of the first compute device;
receiving, at the processor, from the second compute device and during the first time period, a public cryptographic key associated with the first entity, the public cryptographic key having a signature of a private cryptographic key of a second entity;
receiving, at the processor, from the second compute device and during the first time period, a Merkle tree root associated with the credential and having a signature of a private cryptographic key of the first entity;
generating, at the processor, a zero-knowledge proof associated with the credential of the first compute device;
sending, to a third compute device via a peer-to-peer communication, the public cryptographic key, the Merkle tree root, and the zero-knowledge proof during a second time period after the first time period; and
receiving, from the third compute device and in response to the third compute device (1) verifying the Merkle tree root using the public cryptographic key and (2) confirming validity of the zero-knowledge proof using the Merkle tree root, data based on the zero-knowledge proof during the second time period.

15. The method of claim 14, wherein the Merkle tree root is a first Merkle tree root, the connection is a first connection, the peer-to-peer communication is maintained during the second time period and not at a third time period after the second time period, the method further comprising:
initiating, using the processor, a second connection to the second compute device via the network in response to an expiration of the signature of the private cryptographic key of the first entity, the second connection being maintained during the third time period;
receiving, at the processor via the network and during the third time period, a second Merkle tree root having an updated signature of the private cryptographic key of the first entity; and
storing the second Merkle tree root in a cache memory of the first compute device.

16. The method of claim 14, wherein the second compute device is a server, the first compute device is a mobile compute device and the credential is an access entitlement.

17. The method of claim 14, wherein the zero-knowledge proof is generated by a hardware token of the first compute device.

18. The method of claim 14, wherein the Merkle tree root is a root node of a Merkle tree of a plurality of leaf nodes, each node from the plurality of leaf nodes associated with a credential from a plurality of credentials of the first compute device.

19. The method of claim 14, wherein the data allows the first compute device to take control of the third compute device, the method further comprising:
sending, from the processor and to the third compute device via the peer-to-peer communication, a plurality of instructions such that the third compute device executes the plurality of instructions.

20. The method of claim 14, wherein the peer-to-peer communication is at least one of a Bluetooth Low Energy (BLE) communication, a Wi-Fi ad hoc communication or a radio communication.
